(19) United States
(12) Patent Application Publication
(10) Pub. No.: US 2026/0168781 A1
(43) Pub. Date: Jun. 18, 2026

(54) INDUCTIVE SENSOR ASSEMBLY, SYSTEM, AND METHODS

(71) Applicant: Renesas Electronics America Inc., Milpitas, CA (US)

(72) Inventor: Kaloyan Diyanov DANAILOV, Varna (BG)

(73) Assignee: Renesas Electronics America Inc., Milpitas, CA (US)

(21) Appl. No.: 18/983,641

(22) Filed: Dec. 17, 2024

(51) Int. Cl. G01B 7/30; G01B 7/00

(52) U.S. Cl. CPC G01B 7/30; G01B 7/003

(57) ABSTRACT

An inductive sensor assembly is provided. The inductive sensor assembly includes a coil assembly and a movable conductive target. The coil assembly is discontinuously excited by a sequence of signal pulses. The coil assembly includes three coils in a predefined arrangement coupled among three terminals. The movable conductive target at least partly covers the coils during its movement. The inductive sensor assembly is configured for measuring respective currents of the coil assembly at a predetermined time synchronized with excitation of the coil assembly at respective terminals, for determining a displacement of the target.

### TECHNICAL FIELD

The present disclosure is generally directed to techniques related to inductive sensors, and more particularly to techniques related to inductive sensing based on self-inductance.

### BACKGROUND

Inductive position sensing (IPS) is a generally known technology utilized in various applications to measure the position or proximity of metallic objects. Generally speaking, inductive position sensors typically implement a magnet-free technology, utilizing the physical principles of eddy currents or inductive coupling to detect the position of a target that is moving above at least one coil.

In some possible conventional implementations, the inductive sensor operation is generally based on the inductive coupling between a transmitting coil, the target and at least one receiving coil. For instance, in FIG. 1 an exemplary implementation of an induction-based sensor is depicted, using a single transmitting coil and two receiving coils, wherein the two receiving coils are arranged such that one generates a sine and the other a cosine signal every 360° mechanical rotation of the target.

The coils are typically provided as copper traces on a printed circuit board (PCB). They may be arranged such that the transmitter coil induces a secondary voltage in the two receiver coils, which depends on the position of the metallic target above the coils. In some possible examples, the transmitter coil may be provided with an alternating current (AC) signal by an oscillator. This in turn creates a high frequency magnetic field by the transmitter coil, which is picked up by the receiver coils. Depending on the position of the metallic target over the coils, the secondary voltage picked up by the receiver coils may change in amplitude and phase, allowing the determination of the position of the target by analysing these effects.

However, it may be possible to detect the displacement of the target based only on a single coil, because its inductance changes depending on how the target overlaps the coil. Although the principle of operation relies on determining the change in impedance of a single coil by measuring the current flowing through it, in practice a single measurement might not suffice. That is because this measurement may be considered to be vulnerable to external factors such as temperature, mechanical vibrations, etc., which may add an error to both the amplitude and the offset of the measured current.

Therefore, there exists a need for an improved design for the IPS based sensor implementation that can overcome some or all of the problems associated with conventional techniques, and more particularly, that enables objectively determining the position of the target over the coils, preferably with improved energy efficiency and/or reduced complexity.

### SUMMARY

In view of some or all of the above technical problems, the present disclosure generally provides an inductive sensor assembly, a system, and corresponding methods, having the features of the respective independent claims.

According to an aspect of the disclosure, there is provided an inductive sensor assembly (which may sometimes also be referred to herein as a circuit/circuitry design, setup, implementation, or the like). The inductive sensor assembly may comprise a coil assembly for being discontinuously excited by a sequence of signal pulses. In particular, the coil assembly may comprise (at least) three (or even more) coils in a predefined arrangement coupled among three terminals (or connections, ends, etc.). For instance, in some possible examples, the coils in the coil assembly may be identical. The inductive sensor assembly may also comprise a movable conductive (e.g., copper or the like) target that at least partly covers the coils during its movement. More particularly, the inductive sensor assembly may be configured for measuring respective currents of the coil assembly at a predetermined time that is synchronized with excitation of the coil assembly at respective terminals, for determining a (mechanical) displacement (e.g., a (relative) position) of the target. Depending on various implementations, the predetermined time may for example be a predetermined (predefined) time after the end of the excitation pulse, or a predetermined (predefined) time during the excitation pulse. Further, as will become apparent in view of the description below, the inductive sensor assembly as proposed may be configured to determine for example angular (rotational) or linear (or any other suitable) displacement, depending on various implementations and/or circumstances. This is not to be limited in the present application. As used herein throughout the present disclosure, a term “mechanical displacement” may be used to collectively refer to any suitable sort of displacement, such as angular, linear, or any other more complicated trajectory, etc.

Configured as described herein, the present disclosure generally seeks to propose a more energy efficient and reduced-complexity sensor design that enables measuring (determining, estimating, or the like) the (angular or linear) displacement of a target. Further advantages not illustrated here will become apparent in view of the description below.

In some example embodiments, the inductive sensor assembly may be configured for determining an angular displacement of the target. In some possible examples, such angular displacement may be a (relative) angular position (e.g., an angle) with respect to a reference angle. As noted above, in some other possible implementations, the inductive sensor assembly may also be configured for determining a linear displacement of the target. In that case, suitable adaptation of the inductive sensor assembly may become necessary, as can be understood and appreciated by the skilled person.

In some example embodiments, the predefined arrangement may comprise a triangle topology or a star topology in which each of the coils is angularly displaced by a respective predetermined angle with respect to a reference angle (e.g., the 0° reference angle). Of course, any other suitable arrangement of the coil assembly, e.g., parallel, may be possible as well, depending on various implementations and/or circumstances. Also, as may be understood and appreciated by the skilled person, in the case of determining linear position/displacement, the coils may be (linearly) displaced by a respective predetermined distance with respect to a reference position.

In some example embodiments, the coil assembly may be sequentially excited at respective terminals (to which the respective coils are coupled), and the respective current of the coil assembly may be consecutively measured at the respective terminal at the predetermined time after excitation of the respective terminal. It may be worthwhile to mention that, as will be described in greater detail below, in some possible cases, this sequential excitation (stimulation)/consecutive measurement approach may be considered preferable, for example from an application-specific integrated circuit (ASIC) design point of view, generally due to simplifying the internal structure by reusing the same excitation driver and sensing circuit for each of the three terminals of the sensor. However, as can be understood and appreciated by the skilled person, any other suitable implementation, e.g., concurrent measurement, may be possible as well.

In some example embodiments, the coil assembly may be excited in such a manner that when any one of the three terminals is driven to a first predefined (e.g., ‘high’) potential, the other two terminals are put to a second predefined (e.g., ‘low’) potential.

In some example embodiments, the target has a shape designed such that an inductance of the coil assembly (e.g., an equivalent coil inductance) as a function of the angular displacement follows a predetermined mathematical function (formula). As may be understood and apricated by the skilled person, in practice, the shape of the target that fulfills a specific function/formula can be derived by various methodologies, e.g., finite element analysis, electromagnetic (EM) simulation, etc. This is not to be limited in the present disclosure.

In some example embodiments, a respective current Iᵢ of the coil assembly measured at a respective terminal i, i=1, 2, 3, and the corresponding angular displacement of the target φ follow: Iᵢ=Am·sin (φ+φᵢ)+O, where Am represents/denotes a modulation amplitude parameter, O represents/denotes a static and displacement-independent offset parameter, and φᵢ represents/denotes a predetermined displacement angle of a respective coil coupled to the respective terminal i with respect to a reference angle.

In some example embodiments, the angular displacement of the target φ may be determined according to:

$$φ = arctan [ - \frac{( {I}_{2} - {I}_{1} ) sin ( {φ}_{3} ) + ( {I}_{1} - {I}_{3} ) sin ( {φ}_{2} ) + ( {I}_{3} - {I}_{2} ) sin ( {φ}_{1} )}{( {I}_{2} - {I}_{1} ) cos ( {φ}_{3} ) + ( {I}_{1} - {I}_{3} ) cos ( {φ}_{2} ) + ( {I}_{3} - {I}_{2} ) cos ( {φ}_{1} )} ] ,$$

where Iᵢ represents a respective current of the coil assembly measured at a respective terminal i, i=1, 2, 3, and φᵢ represents a predetermined displacement angle of a respective coil coupled to the respective terminal i with respect to a reference angle. Of course, as may be understood and appreciated by the skilled person, analogous or similar determination as for the angular displacement could be applied also for any other suitable type of displacement, for example by equivalent transformation of the respective coordinate systems, or the like. For instance, for linear displacement, the mathematical representation of this transformation may look like: ΔX=X_{R}*(φ/2π), where ΔX denotes the linear displacement and X_{R} denotes the (predetermined) measurement range.

In some example embodiments, the predetermined time after coil excitation at which the currents are measured may be determined based on an L-R time constant of the inductive sensor assembly and its driving circuitry that generates the sequence of signal pulses. To be more specific, as may be understood and appreciated by the skilled person, in practice, the ‘R’ factor may be typically understood to have two components: one coming from the sensor coils (e.g., the resistance of the copper on the PCB, or the like); and another equivalent resistance of the driving circuitry in the ASIC side that is configured to generate the sequence of signal pulses for stimulating/exciting the coil assembly, which is usually dominating.

According to another aspect of the present disclosure, there is also provided a system. In particular, the system may comprise the inductive sensor assembly according to the preceding aspect (and possibly also the example embodiments). The system may also comprise a circuitry assembly (e.g., an ASIC, or the like) coupled to the inductive sensor assembly. More particularly, the circuitry assembly may be configured to discontinuously excite the coil assembly of the inductive sensor assembly by a sequence of signal pulses and to measure the currents of the coil assembly at the predetermined time synchronized with excitation of the coil assembly, for determining the displacement (e.g., angular or linear) of the target of the inductive sensor assembly.

In some example embodiments, the circuitry assembly may be configured to sequentially excite the coil assembly at respective terminals, and the respective current of the coil assembly may be consecutively measured at the respective terminal at the predetermined time after excitation of the respective terminal.

In some example embodiments, the circuitry assembly may be configured to excite the coil assembly such that when any one of the three terminals is driven to a first predefined (e.g., ‘high’) potential, the other two terminals are put to a second predefined (e.g., ‘low’) potential.

In some example embodiments, the system may be further configured for supporting self-diagnostic functionality, which involves: determining a modulation amplitude parameter Am according to:

$$Am = \vert \frac{( {I}_{1} - {I}_{2} ) \cdot \sqrt{1 + {tan}^{2} φ}}{sin ( {φ}_{1} ) - sin ( {φ}_{2} ) + tan ( φ ) \cdot ( cos ( {φ}_{1} ) - cos ( {φ}_{2} ) )} \vert ;$$

determining a static and displacement-independent offset parameter O according to:

$$O = {I}_{3} - \frac{( {I}_{1} - {I}_{2} ) \cdot ( sin ( {φ}_{3} ) + cos ( {φ}_{3} ) \cdot tan ( φ ) )}{sin ( {φ}_{1} ) - sin ( {φ}_{2} ) + tan ( φ ) \cdot ( cos ( {φ}_{1} ) - cos ( {φ}_{2} ) )} ;$$

and determining whether a defect exists in the system based on the determined Am and 0, and respective predetermined tolerance limits thereof. In particular, Iᵢ represents a respective current of the coil assembly measured at a respective terminal i, i=1, 2, 3, φᵢ represents a predetermined displacement angle of a respective coil coupled to the respective terminal i with respect to a reference angle, φ represents an angular displacement of the target, and tan(φ) used for determining the amplitude parameter Am and the offset parameter O is calculated as

$$tan ( φ ) = - \frac{( {I}_{2} - {I}_{1} ) sin ( {φ}_{3} ) + ( {I}_{1} - {1}_{3} ) sin ( {φ}_{2} ) + ( {I}_{3} - {I}_{2} ) sin ( {φ}_{1} )}{( {I}_{2} - {I}_{1} ) cos ( {φ}_{3} ) + ( {I}_{1} - {1}_{3} ) cos ( {φ}_{2} ) + ( {I}_{3} - {I}_{2} ) cos ( {φ}_{1} )} .$$

Thereby, continuous health/flaw monitoring, or in other words, self-diagnostic functionality, may be implemented. Specifically, this may be achieved without additional hardware. Rather, only some extra calculations on the digital domain may be needed, but could deliver very high self-diagnostic coverage for the entire signal path, which may be considered rather important for any safety-critical product.

Further, according to yet another aspect of the present disclosure, there is provided a method using an inductive sensor assembly. The inductive sensor assembly may be analogous or similar to that described above. In particular, the method may comprise providing a coil assembly that is discontinuously excited by a sequence of signal pulses and that comprises three coils in a predefined arrangement coupled among three terminals. The method may further comprise providing a movable conductive target that at least partly covers the coils during its movement, to thereby enable measuring respective currents of the coil assembly at a predetermined time synchronized with excitation of the coil assembly at respective terminals, for determining a displacement of the target.

Similarly, a further aspect of the present disclosure also provides a method using a system. The system may be analogous or similar to that described above. For instance, the system may comprise an inductive sensor assembly that comprises: a coil assembly comprising three (e.g., identical) coils in a predefined arrangement coupled among three terminals; and a (rotationally or linearly) movable conductive target that at least partly covers the coils during its movement. The system may also comprise a circuitry assembly coupled to the inductive sensor assembly. More particularly, the method may comprise: discontinuously exciting, by the circuitry assembly, the coil assembly of the inductive sensor assembly by a sequence of signal pulses; measuring, by the circuit assembly, respective currents of the coil assembly at a predetermined time synchronized with the excitation of the coil assembly at respective terminals; and determining, by the circuit assembly, a displacement (angular or linear) of the target of the inductive sensor assembly based on the measured currents.

Details of the disclosed methods may be implemented as systems (e.g., in the form of circuitry, circuitry assembly, or the like) adapted to execute some or all of the steps of the method, and vice versa, as the skilled person will appreciate. In particular, it is understood that methods according to the present disclosure relate to methods of operating the systems (or circuitry) according to the above embodiments and variations thereof and that respective statements made with regard to the systems (or circuitry) likewise apply to the corresponding methods, and vice versa.

It is also understood that in the present disclosure, the term “couple” or “coupled” refers to elements being in electrical communication with each other, whether directly connected e.g., via wires or in some other manner (e.g., indirectly). Notably, one example of being coupled is being connected.

### BRIEF DESCRIPTION OF THE DRAWINGS

Example embodiments of the disclosure are explained below with reference to the accompanying drawings, wherein like reference numbers indicate like or similar elements, and wherein

FIG. 1 schematically shows an example of a possible implementation of a conventional induction based sensor,

FIG. 2 schematically shows an example illustrating the functional relationship between target displacement and coil inductance by appropriately shaping the target,

FIG. 3 schematically shows an example of a diagram illustrating a possible relationship between a current and an angular displacement of the target when the coil assembly is excited by pulse signal according to some embodiments of the present disclosure,

FIG. 4 schematically illustrates an example of a possible arrangement of coils of an inductive sensor assembly according to some embodiments of the present disclosure,

FIGS. 5A and 5B schematically illustrate examples of possible arrangements of coils according to some embodiments of the present disclosure,

FIGS. 6A and 6B schematically illustrate examples of possible implementations of coil excitation schemes according to some embodiments of the present disclosure,

FIG. 7 schematically illustrates an example of a possible system comprising both an inductive sensor assembly and an application-specific integrated circuit (ASIC) for use with the inductive sensor assembly according to some embodiments of the present disclosure,

FIG. 8 schematically illustrates an example of a possible implementation for determining a linear displacement of the target by equivalent transformation of the respective coordinate systems according to some embodiments of the present disclosure,

FIG. 9 schematically illustrates another example of a possible implementation for determining a linear displacement of the target according to some embodiments of the present disclosure,

FIG. 10 is a flowchart schematically illustrating an example of a method using an inductive sensor assembly according to some embodiments of the present disclosure, and

FIG. 11 is a flowchart schematically illustrating an example of a method using a system according to some embodiments of the present disclosure.

### DETAILED DESCRIPTION

As indicated above, identical or like reference numbers in the present disclosure may, unless indicated otherwise, indicate identical or like elements, such that repeated descriptions thereof may be omitted for reasons of conciseness. Moreover, it is also to be noted that the symbols used in the figures, unless indicated otherwise, are merely for illustrative purposes, and thus should not be understood to constitute a limitation of any kind.

As briefly mentioned above, broadly speaking, this present disclosure generally relates to the technical area of inductive sensors (or sometimes also referred to as induction based sensors), and more particularly to techniques related to inductive sensing based on self-inductance.

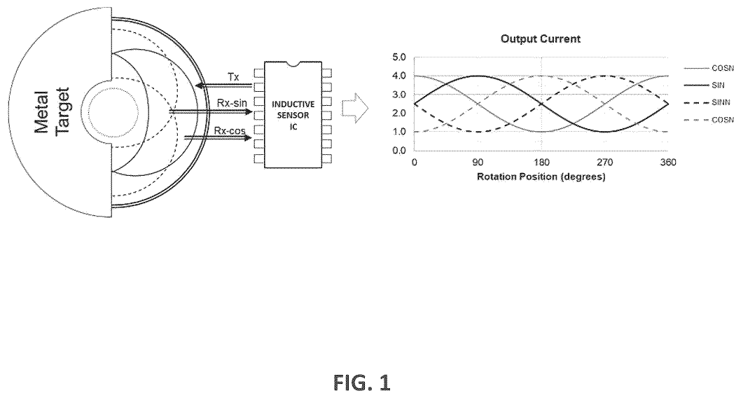

As briefly mentioned earlier, a typical conventional sensor implementation (e.g., the one illustratively shown in FIG. 1) may be configured to perform positioning generally based on the variable mutual inductance between the transmitter coil and the receiving coils.

To the contrary, broadly speaking, techniques proposed in the present disclosure are implemented based on the self-inductance of the sensor coil(s) and its/their dependency on the position of the target. In some possible cases, it may be possible to detect the displacement of the target based only on a single coil, because its inductance changes depending on how the target overlaps the coil.

However, as indicated above, although the principle of operation relies on determining the change in impedance of a single coil by measuring the current flowing through it, in practice a single measurement might not suffice. That is mainly due to the reason that this measurement may be considered to be vulnerable to external factors such as temperature, mechanical vibrations, etc., which may add an error to both the (modulation) amplitude (sometimes also referred to as the signal dynamic range) and the static and displacement-independent offset (sometimes also referred to as the direct current (DC) offset) of the measured current.

In view thereof, generally speaking, one of the primary technical objectives of the present disclosure is finding an improved design for the IPS based sensor implementation that can overcome some or all of the problems associated with conventional techniques, and more particularly, that enables objectively determining the position of the target over the coils, preferably with improved energy efficiency and/or reduced complexity. In doing so, in a broad (certainly non-limiting) term, the present disclosure generally proposes to provide three (e.g., identical) coils (or collectively referred to as a coil assembly) connected/coupled in a fixed and known angular offset, arranged to be supplied with voltage pulses, and to sample the current at a fixed time after the (aperiodic) charge/discharge process has started.

Generally speaking, the pulse based driving scheme may be considered to bring several benefits, which include (but are not limited to): simplicity of the coil driving circuit; lower spectral density and average levels of the emitted electromagnetic (EM) disturbance; higher energy efficiency; control over pulse width and period for allowing easy adaptation to a wide range of inductive sensors and specific application requirements (e.g., in terms of speed, current consumption, EMC, etc.); or the like. Of course, any other applicable implementations, objectives and/or advantages of the present disclosure would also become apparent in view of the detailed description below.

It may be worth noting that although many of the examples described below may seem to refer to or focus on some possible implementations for determining an angular displacement of a (rotationally or angularly movable) target, the techniques proposed herein may also be suitably applicable for determining a linear (or any other suitable mechanical) displacement of a (linearly movable) target, as can be understood and appreciated by the skilled person. In any case, for the sake of illustration, some possible example implementations for suitably determining the linear displacement of the target will also be described in more detail below.

First, the sensor part will be described.

Particularly, when a conductive (e.g., copper or the like) plate, or sometimes also referred to as a target, covers a portion (S_{c}) of the total cross-section of a coil (Sₒ) then due to eddy currents induced on the plate and the associated effect on the magnetic field passing through the coil, the equivalent inductance of the coil (Lₑ) may become a fraction of the original inductance (Lₒ). In some possible examples, the equivalent inductance may be reduced according to the following formula/equation (1):

$${L}_{e} = {L}_{o} \cdot ( 1 - \frac{{S}_{c}}{{S}_{o}} ) \qquad ( 1 )$$

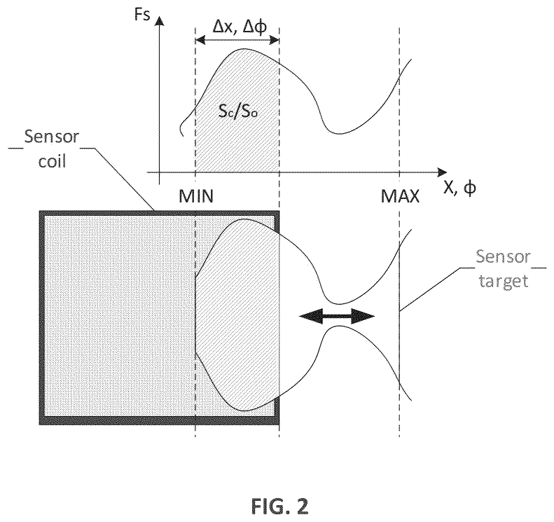

Thus, by shaping the target appropriately, the relationship between (mechanical) displacement (e.g., Δφ in terms of angular displacement or Δx in terms of linear displacement) and coil inductance may be suitably made to follow any mathematical function (e.g., denoted as Fₛ (Δφ)) which is differentiable within the measurement range (see for instance the diagram illustratively shown in FIG. 2). According, the above formula (1) may be expressed as follows:

$${L}_{e} = {L}_{o} \cdot ( 1 - {F}_{s} ( Δφ ) ) \qquad ( 2 )$$

As indicated above, with proper target shaping, the sensor modulation function could be controlled according to the system needs. Herein, for angular (or similarly also for linear) measurement, an appropriately shaped target may be any target that results in Lₑ being expressed in any suitable mathematical representation, such as:

$${L}_{e} ( φ ) = - {L}_{0} / ln ( 1 - K \cdot ( 1 + M \cdot sin ( φ ) ) ) \qquad ( 3 )$$

In particular, parameter K may be seen to generally define the relative sampling instance with respect to the L-R time-constant of the coil, and K=1−e^{-T}^{₀}^{R}/Lₒ. In some possible cases, the sampling instance may be, but is certainly not restricted to, T₀=L₀/R, which may be understood to correspond to maximum sensitivity. In general terms, it may be understood that the predetermined time T₀ after coil excitation at which the currents are measured may be determined based on an L-R time constant of the inductive sensor assembly and its driving circuitry that generates the sequence of signal pulses. Particularly, the “R” factor generally has two components: one coming from the sensor coils (e.g., resistance of the copper on the PCB), and another equivalent resistance of the driving circuitry in the ASIC, which may be usually dominating.

Moreover, parameter M may be seen as the selected modulation index for the sensor, i.e., how much the equivalent inductance Lₑ(φ) would be changing by the target displacement q, and M∈(0÷(1−K)/K) (or simply M∈(0,(1−K)/K)).

As may be understood and appreciated by the skilled person, in practice, the shape of the target that can produce an Lₑ according to the above formula (3) may be derived by any suitable methods, e.g., finite element analysis, EM simulation, etc., depending on various implementations and/or circumstances.

With a single coil, it can be shown that the current on the coil may depend on the displacement of the target over the coil. For an angular displacement q, at the predetermined sampling time T₀, the current would be:

$$I ( φ , {T}_{0} ) = {I}_{0} ( 1 - {e}^{- \frac{{τ}_{0}}{{L}_{e} ( φ ) / R}} ) \qquad ( 4 )$$

where Lₑ(φ) is the equivalent coil inductance for displacement φ, and R is the resistance in series with the coil.

Accordingly, in some possible implementations, if a rectangular voltage pulse is provided to the coil, measuring the current after T₀ (e.g., after the end of the excitation pulse, or during the excitation pulse) would in theory allow determining the (relative) position of the target.

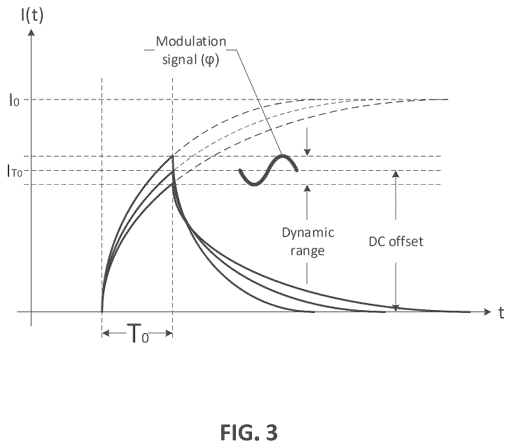

In some possible implementations, for example for a sensor being configured for measuring angular displacement, when formula (3) is substituted in the generalized formula (4) above, it may be further simplified to:

$$I ( φ ) = Am \cdot sin ( φ ) + O \qquad ( 5 )$$

where parameter Am may be seen to generally represent the signal (modulation) amplitude (which generally corresponds to the dynamic range illustratively shown in FIG. 3), and parameter O may be seen to generally represent a static and displacement-independent offset (which generally corresponds to the DC offset illustratively shown in FIG. 3).

If both parameters Am and O are known, a single measurement of the current I_{T0}(φ) would be enough for calculating the position φ, However, as mentioned above, one of the problems here may be that both parameters Am and O may be somehow affected by various external factors, like temperature, mechanical vibrations, air gap change, etc., and therefore may not be considered known.

In other words, although in theory, a sensor with a single coil might potentially allow determining that a target has moved and potentially derive how much it has rotated, such sensor arrangement would however suffer from very low accuracy and reproducibility.

Accordingly, in order to solve this problem and to determine the actual angular position of the target in an objective manner, it may become necessary to be able to determine all of the unknowns of the above equation (5), i.e., all of the parameters Am, φ and O. Broadly speaking, this would in turn require obtaining two additional data points and solving the system of equations below with respect to the angular displacement φ:

$$\{ \begin{matrix}A = Am \cdot sin ( φ + {φ}_{1} ) + O \\ B = Am \cdot sin ( φ + {φ}_{2} ) + O \\ C = Am \cdot sin ( φ + {φ}_{3} ) + O\end{matrix} \qquad ( 6 )$$

It may be worthwhile noting that, the letters A, B and C used herein are merely for the sake of easy illustration. As can be understood and appreciated by the skilled person, they essentially correspond to respective currents measurable according to the above formula (5), and thus could be easily replaced by Iᵢ where i=1, 2, 3, respective.

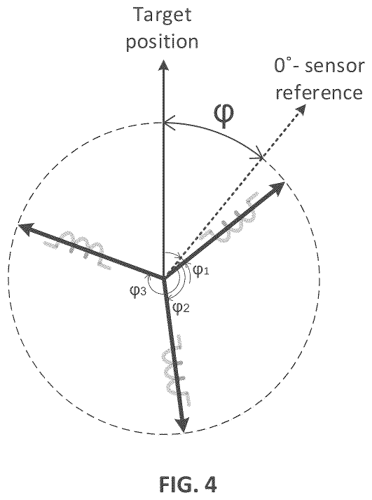

In some possible examples, a simple approach to implement this would be to add two additional measurement probes (coils) in the sensor assembly, displaced at fixed (e.g., predetermined or the like) angles (φ₂ and φ₃) with respect to the 0° reference angle. Accordingly, an example of an angular displacement of the target results in three currents with three different phases is illustratively shown in FIG. 4. As indicated above, in some possible cases, these three coils may also be collectively referred to as a coil assembly. Notably, in the example of FIG. 4, the coils may seem to be evenly displaced (120°) within the circle, this does not necessarily have to be always the case. For instance, in some possible examples, only a fraction/part of the full measurement range (corresponding to the full circle) may be of interest for some possible applications, then the coils may be suitably placed accordingly, for example at different angles in the circle.

In this way, it can be shown that the angular displacement φ can then be mathematically determined when the system of equations (6) is solved with respect to q:

$$φ = arctan [ - \frac{( B - A ) sin ( {φ}_{3} ) + ( A - C ) sin ( {φ}_{2} ) + ( C - B ) sin ( {φ}_{1} )}{( B - A ) cos ( {φ}_{3} ) + ( A - C ) cos ( {φ}_{2} ) + ( C - B ) cos ( {φ}_{1} )} ] \qquad ( 7 )$$

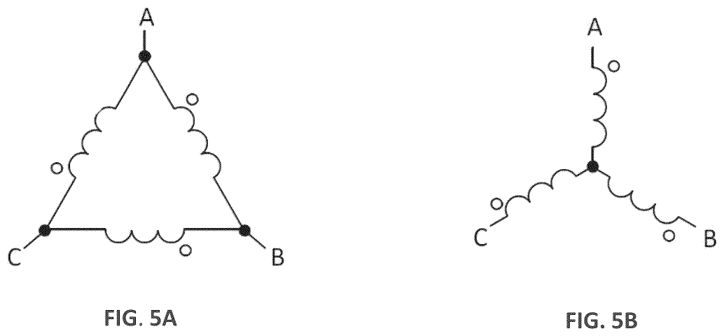

As indicated above, A, B and C are generally used to denote the three currents measured at the three corresponding pins/terminals A, B and C shown in FIGS. 5A and 5B, and φ₁, φ₂ and φ₃ are (predetermined) constants as mentioned above, defined by the suitable arrangements of the three coils in the sensor assembly.

It may be worthwhile to note that, in some possible implementations, calculating the angle q based on equation (7) above may be based on subtracting the (current) values of A, B and C, which can be easily implemented on the analog domain. In particular, this may enable eliminating any common DC offset, and allow using the full range of the analog-to-digital converter (ADC) in the signal path, as will be described in more detail below with respect to the ASIC design.

Depending on various implementations and/or requirements, the coils may be set up in any suitable arrangement. For instance, in some possible implementations, the coils can be set up in a triangle topology (FIG. 5A) or a star topology (FIG. 5B) in which case the measurements on each pin/terminal may take place consecutively.

In some possible examples, the star topology might be also converted into a parallel topology, for example if the center of the star is coupled to a predetermined reference potential/node (e.g., ground). In such case, it would also be possible that the currents on pins A, B and C could be measured concurrently. That is, the sensor coils could be stimulated/measured at the same time with dedicated for each channel driver/sense circuits and all other considerations would remain the same. This configuration may be considered applicable to some particular cases, such as those when high accuracy for fast moving targets is required by the application.

On the other hand, although measuring the currents at A, B and C in parallel would be possible at least in theory (e.g., with the center of the star topology of FIG. 5B grounded as illustrated above), this particular arrangement may, in some other particularly cases, be considered less preferable in comparison with the cases of using the star or triangle topology and measuring the currents at A, B and C consecutively as described earlier. One of the main reasons here may be understood as in order to excite and measure the current on A, B, and C concurrently, implementation of three identical driver/sense circuits would be potentially needed, that work in parallel. Conversely, the consecutive measurement scheme would generally require a single ASIC, thereby resulting in, among others, reduced size, cost and complexity.

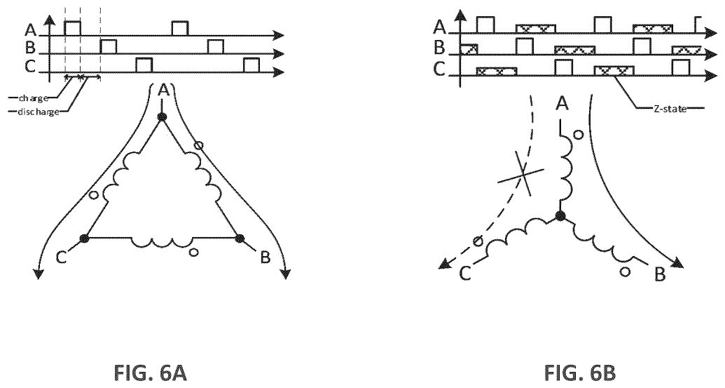

In order to be able to measure the currents at terminals A, B and C, any suitable methodology can be used, depending on various implementations and/or circumstances. For instance, in the case of the triangle topology/arrangement, the following excitation sequence may be used to generate currents on the coils, as illustratively shown in FIG. 6A.

In particular, the coils may be sequentially excited/stimulated at respective terminals A, B and C by the respective pulses shown in FIG. 6A (indicated as ‘charge’), thereby allowing the respective currents of the coils to be consecutively measured at the predetermined time T₀ after the excitation of the respective terminals. Specifically, as illustratively shown in FIG. 6A, the coils may be excited in such a manner that when any one of the three terminals A, B and Cis driven to a first predefined potential (for example ‘high’), the other two terminals are put/set to a second predefined potential (for example ‘low’). Put differently in simple words, there is no floating node/terminal/pin at any time during the excitation of the coils.

The above excitation/stimulation sequence would also work with the star topology, as can be understood and appreciated by the skilled person.

For the sake of completeness, it may be worthwhile to mention that, in some other possible examples, an alternative excitation/stimulation method may be used with the star topology as well, as illustratively shown in FIG. 6B. Of course, as can be understood and appreciated by the skilled person, such excitation/stimulation may be suitably applicable to the triangle (or any other suitable) topology as well.

In particular, as can be seen from FIG. 6B, one of A, B, C pins is always floating (indicated as ‘Z state’). Nevertheless, it is noticed that, in some possible cases, if one of A, B, or C is left floating after a current has flown through it, undesirable electromagnetic fields (EMF) spikes may be generated. Thus, in the preferred embodiments, none of the nodes should be left floating at any time, as indicated above. In other words, regardless of which of the two topologies are selected, in the preferred embodiments, terminals A, B and C are being driven such that one of the A, B, C is ‘high’ (or any other suitable reference potential), and the other two are ‘low’ (or any other suitable reference potential).

The driving schemes illustrated above may be seen to result in measurement of two sensor coils simultaneously. That is also one of the reasons why, for such configurations, the above formula (3) shall be applied to the total equivalent inductance Lₑ of the coil assembly, rather than to the single coils. In some possible cases, this may in turn make the system more sensitive to asymmetries in the three driving channels. However, as can be understood and appreciated by the skilled person, it may be still worth noting that the proposed techniques are preferable from practical implementation point of view.

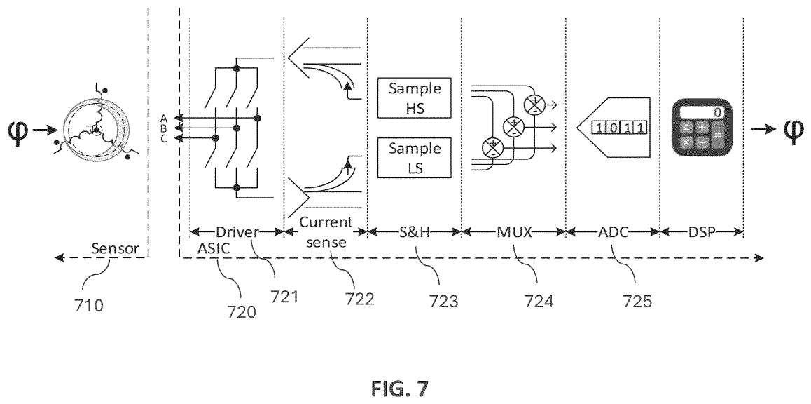

Now, reference is made to the ASIC side. In particular, a possible (certainly non-limiting) implementation of an example topology of the ASIC 720 that is used in conjunction with the sensor 710 described above is illustratively shown in FIG. 7. Generally speaking, the ASIC 720 provides a voltage pulse (e.g., rectangularly shaped or the like) on one of the A, B or C, and measures the sample at a predefined time after the charge-discharge process of the coils has started. As such, the ASIC 720, particularly when used in combination with the sensor 710 described above, allows passing the necessary information to the digital domain to solve the above equation (7), whilst making full use of the dynamic range of the ADC 725, as indicated above.

In particular, the driver stage 721 may be configured to apply the above described excitation/stimulation and measuring schemes to the three ends (A, B and C) of the coils. Notably, whilst in conventional sensor implementations (such as the one shown in FIG. 1) the coils are typically stimulated with an AC current from an oscillator, in the present disclosure the ASIC may provide (e.g., square, rectangular, or the like) pulses to the coil assembly to discontinuously excite the coils. As will be understood and appreciated by the skilled person, exciting the transmitter coil with short (discontinuous) pulses may be considered to have at least the following effects. First, a glitch-like excitation signal (e.g., short rectangular pulse) typically has a quite wide spectrum bandwidth, enabling the spread of its energy over a wider frequency band. This results in lowering of the spectral density of the electromagnetic noise which such system generates during its operation, hence improving its EMC performance. Further, the power consumption of the sensor can be significantly reduced, as there would not be a continuous supply of current to the coils necessary, in comparison to the AC current based conventional techniques. Accordingly, the ASIC may also be powered in synchronization with the sequence of pulses. Moreover, there would also be no need for a rectifier as both the currents supplied to the coils and the currents induced are already in a form suitable for further processing. And finally, the design of the excitation generator can be greatly simplified as well. In some possible examples, the clocking scheme for the generation of the pulses may be randomized (e.g., by use of an analog random generator or the like). Thereby, the electromagnetic disturbances that the coil may cause for neighboring circuits may be greatly reduced. In addition, the use of the randomized clock scheme may break any possible correlation with for example external disturbance signals, thereby bringing a positive effect for increasing the system immunity against electromagnetic interference.

Further, the current sense stage 722 and sample and hold stage 723 generally enable sampling the currents at all three phases of the measurement, and, with the help of the MUX stage 724, selecting and subtracting the currents at A, B and C.

As a result, the calculation of (B-A), (A-C), (C-B) for the above equation (7) may be seen to be able to take place in the analog domain, cancelling the signals' DC offset and thus enabling full utilization of the ADC dynamic range by the dynamic component of the information signal. The rest of the system/circuitry follows known receiving path topologies, and thus will not be discussed in detail here for the sake of conciseness.

Of course, as can be understood and appreciated by the skilled person, this exemplary implementation of the ASIC 720 shown in FIG. 7 is merely provided as one possible example for illustrative purposes, and should not be understood to constitute a limitation of any kind.

Depending on various circumstances and/or requirements, any other suitable implementation of the ASIC may be adopted as well.

It may be worth noting that the proposed ASIC architecture, particularly when used in combination with the proposed sensor assembly, may be considered to generally enable a number of advantages too, namely:
The differential signal path proposed herein may be considered to be immune to common-mode and power supply disturbances.
The information is carried by current flow rather than voltage potentials, making it insensitive to voltage drops (e.g., I*R drops), parasitic coupling, etc.
In the case of a star topology, the equivalent inductance Lₑ(φ) would always be greater than that of the individual coils. A higher inductance in this case may be considered preferable for sensor sensitivity and ASIC electrical requirements, which aids in sensor miniaturization.
The currents from the sensor may be sampled and subtracted in the analog domain, resulting in upfront canceling of the signal's DC offset, which may in turn enable full utilization of the ADC dynamic range by the dynamic component of the information signal.
And finally, complex signal post-processing may be completely moved to the digital domain.

It is also to be noted that the overall system (i.e., the combination of the sensor and the ASIC illustrated above) may be considered to bring further benefits from continuous health/flaw monitoring.

To be more specific, in the case that the sensor malfunctions in some manner, the derived values for parameters Am and O may be used to determine if there is an error. Similarly to the above equation (7), the other two unknowns, i.e., the amplitude parameter Am and the offset parameter O, may be determined, from the system of equations (6), by using the following equations (8) and (9) respectively:

$$Am = \vert \frac{( A - B ) \cdot \sqrt{1 + {tan}^{2} φ}}{sin ( {φ}_{1} ) - sin ( {φ}_{2} ) + tan ( φ ) \cdot ( cos ( {φ}_{1} ) - cos ( {φ}_{2} ) )} \vert \qquad ( 8 )$$

$$O = C - \frac{( A - B ) \cdot ( sin ( {φ}_{3} ) + cos ( {φ}_{3} ) \cdot tan ( φ ) )}{sin ( {φ}_{1} ) - sin ( {φ}_{2} ) + tan ( φ ) \cdot ( cos ( {φ}_{1} ) - cos ( {φ}_{2} ) )} \qquad ( 9 )$$

It may be worthwhile to mention that, in the above equations (8) and (9), tan (o) used for determining the amplitude parameter Am and the offset parameter O may be calculated based on equation (7) as:

$$tan ( φ ) = - \frac{( B - A ) sin ( {φ}_{3} ) + ( A - C ) sin ( {φ}_{2} ) + ( C - B ) sin ( {φ}_{1} )}{( B - A ) cos ( {φ}_{3} ) + ( A - C ) cos ( {φ}_{2} ) + ( C - B ) cos ( {φ}_{1} )} \qquad ( 10 )$$

In case of defect or malfunction, the values of those two parameters may go beyond the narrow tolerance limits (e.g., defined by the natural but relatively small process, voltage and temperature (PVT) variations, etc.), thereby triggering a suitable alarm signal or the like.

Notably, the above illustrated self-diagnostic functionality generally requires no additional hardware. It is only extra calculations on the digital domain that are needed to provide this benefit, but may deliver very high self-diagnostic coverage for the entire signal path, which may be considered a rather important requirement for any safety-critical product.

It may be worthwhile to also mention that, in some possible cases, the system would also allow simplified and cost-effective calibration for potential channel-to-channel asymmetries. Such asymmetries would translate as angular error and non-linearity. In particular, once the system is manufactured, measurement at only three data points (target positions) during production tests would enable determination of the individual φᵢ and amplitudes for each channel (A, B, and C), which could be further stored as normalization data on the ASIC that can be used to calibrate the sensor accordingly.

Moreover, as noted earlier, although many of the examples illustrated above may seem to refer to or focus on the determination of an angular displacement of a (rotationally or angularly movable) target, the techniques proposed herein may also be applied (e.g., with suitable adaptation or the like) for determining a linear displacement of a (linearly movable) target as well. For the sake of completeness, some possible (certainly non-limiting) examples will be described with reference to the figures as follows, schematically illustrating some general principles regarding linear displacement determination.

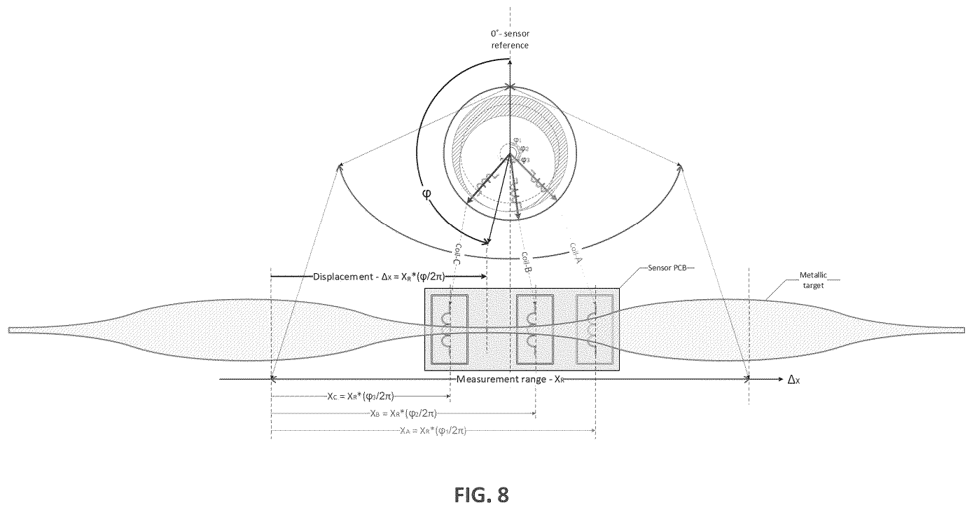

A first example implementation shown in FIG. 8 may be considered relatively straightforward, in the sense that it generally illustrates a possible transformation between the polar coordinate system described above for determining the angular displacement and the cartesian coordinate system that could be used for determining the linear displacement, and also how the coil arrangement and target shape might change in the case of linear displacement determination.

Specific for this simple sensor arrangement implementation is that the coils' PCB could be relatively small. However, as illustratively shown in FIG. 8, in this example the target length would be twice longer than the measurement range, which might be considered unsuitable for some potential applications.

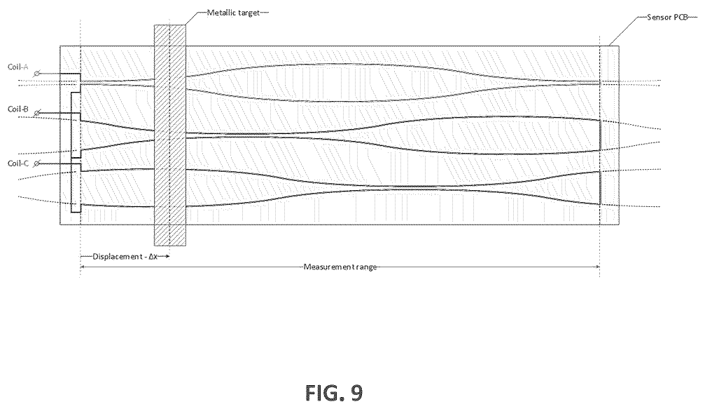

As a second possible example implementation of linear displacement determination, FIG. 9 schematically illustrates a linear position sensor with parallel arrangement (topology) of the coils, which generally enables a smaller size and simpler shape of the target, which might in turn be considered a preferable embodiment for many of the industrial applications. Broadly speaking, as may also be understood and appreciated by the skilled person, in this specific example the required mathematical relation/function between the target position and the self-inductance of the coils may be achieved by proper shaping of the coil windings.

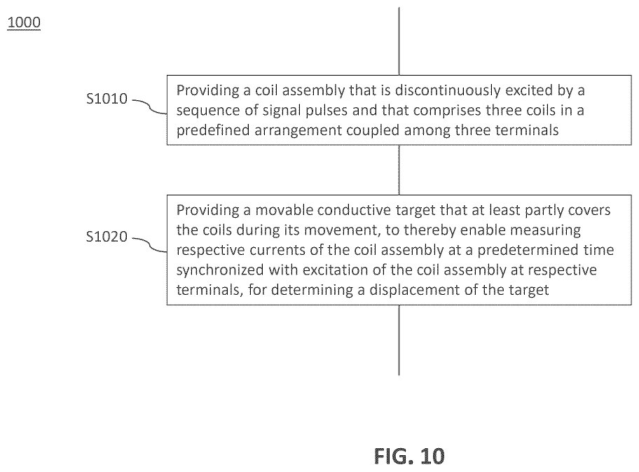

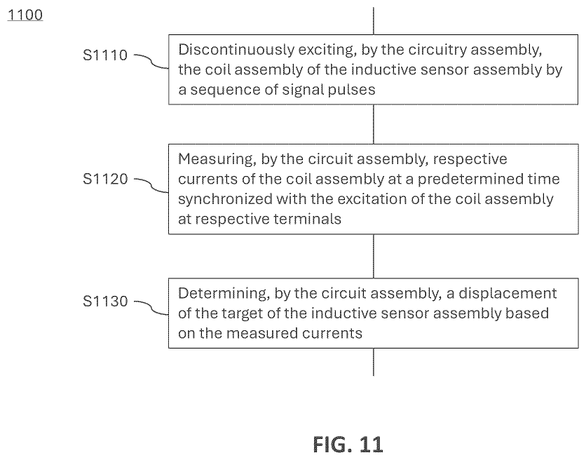

Finally, flowcharts illustrating possible example methods according to some example embodiments of the present disclosure are schematically shown in FIGS. 10 and 11.

In particular, FIG. 10 schematically illustrates an example of a method 1000 using an inductive sensor assembly according to some embodiments of the present disclosure. The inductive sensor assembly may be analogous or similar to that described above with respect to the figures, or the like. In particular, the method 1000 may comprise, at step S1010, providing a coil assembly that is discontinuously excited by a sequence of signal pulses and that comprises three coils in a predefined arrangement coupled among three terminals. The method 1000 may further comprise, at step S1020, providing a movable conductive target that at least partly covers the coils during its movement, to thereby enable measuring respective currents of the coil assembly at a predetermined time synchronized with excitation of the coil assembly at respective terminals, for determining a displacement of the target.

Similarly, FIG. 11 schematically illustrates an example of a method 1100 using a system according to some embodiments of the present disclosure. The system may be analogous or similar to that described above with respect to the figures, or the like. For instance, the system may comprise an inductive sensor assembly that comprises: a coil assembly comprising three (e.g., identical) coils in a predefined arrangement coupled among three terminals; and a (rotationally or linearly) movable conductive target that at least partly covers the coils during its movement. The system may also comprise a circuitry assembly coupled to the inductive sensor assembly. More particularly, the method 1100 may comprise, at step S1110, discontinuously exciting, by the circuitry assembly, the coil assembly of the inductive sensor assembly by a sequence of signal pulses. The method 1100 may further comprise, at step S1120, measuring, by the circuit assembly, respective currents of the coil assembly at a predetermined time synchronized with the excitation of the coil assembly at respective terminals. And finally, the method 1100 may comprise, at step S1130, determining, by the circuit assembly, a displacement (angular or linear) of the target of the inductive sensor assembly based on the measured currents.

Techniques proposed in the present disclosure also bring several further advantages, which include (but are certainly not limited to): high configurability, generally meaning that a single product may be configured to cover many application cases; no demanding analog part, resulting in relatively easy for implementation; availability of easy to use high coverage self-diagnostic method for the whole signal path; ready for higher automotive safety integrity levels (ASILs); high EMC robustness; low current consumption; low cost of goods sold (COGS); and minimized bill of material (BOM) of external components.

It may be worth noting that, the exemplary implementations using coils that may appear to have a specific wound, arrangement or placement as shown in the figures are merely provided for possible illustrative purposes, but are certainly not to be understood as a limitation of any kind. As can be understood and appreciated by the skilled person, any other suitable arrangement, implementation and/or application may be adopted.

It should be noted that the circuitry/system features described above correspond to respective method features that may however not be explicitly described, for reasons of conciseness. The disclosure of the present document is considered to extend also to such method features. In particular, the present disclosure is understood to also relate to methods of manufacturing and/or operating the circuitry/system described above, and/or to providing and/or arranging respective elements of the circuitry/system.

It is to be further noted that examples of embodiments of the disclosure are applicable to various applications or system configurations, depending on the underlying technical fields. In other words, the examples shown in the above-described figures, which are used as a basis for the above discussed examples, are only illustrative and do not limit the present disclosure in any way. That is, additional further existing and proposed new functionalities available in a corresponding operating environment may be used in connection with examples of embodiments of the present disclosure based on the principles defined.

Finally, it should be noted that the description and drawings merely illustrate the principles of the proposed circuits and methods. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed method. Furthermore, all statements herein providing principles, aspects, and embodiments of the invention, as well as specific examples thereof, are intended to encompass equivalents thereof.

1. An inductive sensor assembly comprising:
a coil assembly for being discontinuously excited by a sequence of signal pulses, wherein the coil assembly comprises three coils in a predefined arrangement coupled among three terminals; and
a movable conductive target that at least partly covers the coils during its movement,
wherein the inductive sensor assembly is configured for measuring respective currents of the coil assembly at a predetermined time synchronized with excitation of the coil assembly at respective terminals, for determining a displacement of the target.

2. The inductive sensor assembly according to claim 1, wherein the inductive sensor assembly is configured for determining an angular displacement of the target.

3. The inductive sensor assembly according to claim 2, wherein
the predefined arrangement comprises a triangle topology or a star topology in which each of the coils is angularly displaced by a respective predetermined angle with respect to a reference angle.

4. The inductive sensor assembly according to claim 2, wherein
the coil assembly is sequentially excited at respective terminals, and the respective current of the coil assembly is consecutively measured at the respective terminal at the predetermined time after excitation of the respective terminal.

5. The inductive sensor assembly according to claim 2, wherein
the coil assembly is excited in such a manner that when any one of the three terminals is driven to a first predefined potential, the other two terminals are put to a second predefined potential.

6. The inductive sensor assembly according to claim 2, wherein
the target has a shape designed such that an inductance of the coil assembly as a function of the angular displacement follows a predetermined mathematical function.

7. The inductive sensor assembly according to claim 2, wherein
a respective current Iᵢ of the coil assembly measured at a respective terminal i, i=1, 2, 3, and the corresponding angular displacement of the target φ follow: Iᵢ=Am·sin(φ+φᵢ)+O, where Am represents a modulation amplitude parameter, O represents a static and displacement-independent offset parameter, and φᵢ represents a predetermined displacement angle of a respective coil coupled to the respective terminal i with respect to a reference angle.

8. The inductive sensor assembly according to claim 2, wherein the angular displacement of the target φ is determined according to:
$$φ = arctan [ - \frac{( {I}_{2} - {I}_{1} ) sin ( {φ}_{3} ) + ( {I}_{1} - {I}_{3} ) sin ( {φ}_{2} ) + ( {I}_{3} - {I}_{2} ) sin ( {φ}_{1} )}{( {I}_{2} - {I}_{1} ) cos ( {φ}_{3} ) + ( {I}_{1} - {I}_{3} ) cos ( {φ}_{2} ) + ( {I}_{3} - {I}_{2} ) cos ( {φ}_{1} )} ] ,$$
where Iᵢ represents a respective current of the coil assembly measured at a respective terminal i, i=1, 2, 3, and φᵢ represents a predetermined displacement angle of a respective coil coupled to the respective terminal i with respect to a reference angle.

9. The inductive sensor assembly according to claim 2, wherein
the predetermined time after coil excitation at which the currents are measured is determined based on an L-R time constant of the inductive sensor assembly and its driving circuitry that generates the sequence of signal pulses.

10. A system comprising:
the inductive sensor assembly according to claim 1; and
a circuitry assembly coupled to the inductive sensor assembly,
wherein the circuitry assembly is configured to discontinuously excite the coil assembly of the inductive sensor assembly by a sequence of signal pulses and to measure the currents of the coil assembly at the predetermined time synchronized with excitation of the coil assembly, for determining the displacement of the target of the inductive sensor assembly.

11. The system according to claim 10, wherein
the circuitry assembly is configured to sequentially excite the coil assembly at respective terminals, and the respective current of the coil assembly is consecutively measured at the respective terminal at the predetermined time after excitation of the respective terminal.

12. The system according to claim 10, wherein
the circuitry assembly is configured to excite the coil assembly such that when any one of the three terminals is driven to a first predefined potential, the other two terminals are put to a second predefined potential.

13. The system according to claim 10, wherein the system is further configured for supporting self-diagnostic functionality, which involves:
determining a modulation amplitude parameter Am according to:
$$Am = \vert \frac{( {I}_{1} - {I}_{2} ) \sqrt{1 + {tan}^{2} φ}}{sin ( {φ}_{1} ) - sin ( {φ}_{2} ) + tan ( φ ) \cdot ( cos ( {φ}_{1} ) - cos ( {φ}_{2} ) )} \vert ;$$
determining a static and displacement-independent offset parameter O according to:
$$O = {I}_{3} - \frac{( {I}_{1} - {I}_{2} ) \cdot ( sin ( {φ}_{3} ) + cos ( {φ}_{3} ) \cdot tan ( φ ) )}{sin ( {φ}_{1} ) - sin ( {φ}_{2} ) + tan ( φ ) \cdot ( cos ( {φ}_{1} ) - cos ( {φ}_{2} ) )} ;$$
and
determining whether a defect exists in the system based on the determined Am and O, and respective predetermined tolerance limits thereof,
where Iᵢ represents a respective current of the coil assembly measured at a respective terminal i, i=1, 2, 3, φᵢ represents a predetermined displacement angle of a respective coil coupled to the respective terminal i with respect to a reference angle, φ represents an angular displacement of the target, and tan(φ) used for determining the modulation amplitude parameter Am and the static and displacement-independent offset parameter O is calculated as
$$tan ( φ ) = - \frac{( {I}_{2} - {I}_{1} ) sin ( {φ}_{3} ) + ( {I}_{1} - {I}_{3} ) sin ( {φ}_{2} ) + ( {I}_{3} - {I}_{2} ) sin ( {φ}_{1} )}{( {I}_{2} - {I}_{1} ) cos ( {φ}_{3} ) + ( {I}_{1} - {I}_{3} ) cos ( {φ}_{2} ) + ( {I}_{3} - {I}_{2} ) cos ( {φ}_{1} )} .$$

14. A method using an inductive sensor assembly, comprising:
providing a coil assembly that is discontinuously excited by a sequence of signal pulses and that comprises three coils in a predefined arrangement coupled among three terminals; and
providing a movable conductive target that at least partly covers the coils during its movement,
to thereby enable measuring respective currents of the coil assembly at a predetermined time synchronized with excitation of the coil assembly at respective terminals, for determining a displacement of the target.

15. A method using a system, the system comprising:
an inductive sensor assembly that comprises:
a coil assembly comprising three coils in a predefined arrangement coupled among three terminals; and
a movable conductive target that at least partly covers the coils during its movement; and
a circuitry assembly coupled to the inductive sensor assembly,
wherein the method comprises:
discontinuously exciting, by the circuitry assembly, the coil assembly of the inductive sensor assembly by a sequence of signal pulses;
measuring, by the circuit assembly, respective currents of the coil assembly at a predetermined time synchronized with the excitation of the coil assembly at respective terminals; and
determining, by the circuit assembly, a displacement of the target of the inductive sensor assembly based on the measured currents.
